(19) United States
(12) Patent Application Publication
(10) Pub. No.: US 2004/0042663 A1
(43) Pub. Date: Mar. 4, 2004

(54) Method, apparatus, and program for similarity judgment

(75) Inventor: Masahiko Yamada, Kanagawa-ken (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/644,759

(22) Filed: Aug. 21, 2003

(30) Foreign Application Priority Data
Aug. 28, 2002 (JP) 249207/2002

(51) Int. Cl. G06K 9/64

(52) U.S. Cl. 382/217

(57) ABSTRACT

Similarity is judged with accuracy between images. Two image data sets are input to input means and metadata sets attached thereto are extracted. The metadata sets include characteristic information on objects included in images represented by the two image data sets. Object evaluation means calculates evaluation values representing similarity between the objects, based on the characteristic information. Image evaluation means calculates a similarity value between the two images, based on the evaluation values. Image classification means classifies the image data sets according to the similarity value and stores the image data sets in storage means together with a classification result.

### BACKGROUND OF THE INVENTION

1. Field of the Invention

The present invention relates to a similarity judgment method and a similarity judgment apparatus for judging similarity between images. The present invention also relates to a program that causes a computer to execute the similarity judgment method.

2. Description of the Related Art

In order to prevent illegal copying of image data, a method of finding similarity between image data of an original work and image data other than the original image data has been proposed (Japanese Unexamined Patent Publication No. 11(1999)-53541). Furthermore, a method of searching a database that stores image data for finding similar image data has also been proposed (Japanese Unexamined Patent Publication No. 2000-29885). In those methods, when similarity between images is calculated, characteristic quantities are generated from an outline and a shape of a subject included in an image, position of a texture region in the image, and color and brightness information of the image, for example. Characteristic vectors are then calculated by using the characteristic quantities, and the similarity is judged based on inner product or distance between the characteristic vectors. By using such methods, illegal copies can be found or a similar image can be searched for, according to similarity between images.

However, in the case where similarity between images is judged based on characteristic quantities such as those described above, the images may not look similar in some cases even if the images have been judged to be similar. For example, if two images having people as subjects thereof have been judged to be similar according to the characteristic quantities, the images are judged to be not similar when viewed by a human observer, if the number of persons therein is not the same in the two images. Furthermore, in the case where images having dominant blue sky and dominant blue sea are compared to each other, the images are judged to be similar if color information thereof is used as the characteristic quantities. However, a human observer judges the two images to be completely different.

### SUMMARY OF THE INVENTION

The present invention has been conceived based on consideration of the above circumstances. An object of the present invention is therefore to accurately judge similarity between images.

A similarity judgment method of the present invention is a method of judging a similarity value between images related to or attached with characteristic information representing a characteristic of each of objects therein, and the similarity judgment method comprises the steps of:

calculating a similarity value between the objects included in the images, based on the characteristic information;

calculating the similarity value between the images, based on the similarity value between the objects.

The objects refer to subjects included in the images, such as a person, the sky, the sea, a tree, and a building.

The characteristic information refers to a candidate of the name of each of the objects, a reliability value representing likelihood of each of the objects having the name, position information representing a position of each of the objects in a corresponding one of the images, size information representing a size of each of the objects, and statistic values such as averages or variances of characteristic quantities regarding color and brightness of each of the objects, for example.

Being attached with the characteristic information refers to a state wherein the characteristic information is described in tag information of image data representing the images, for example. Being related to the characteristic information refers to a state wherein the characteristic information is organized as a file different from a file of the image data but not separated from the image data, for example.

It is preferable that more than one candidate of the name of each of the objects to be used, since it is not known whether a blue object refers to the sea or the sky, for example.

In the similarity judgment method of the present invention, the images may be classified and stored according to the similarity value between the images.

In this case, the stored images may be output sequentially according to the similarity value between the images.

Furthermore, in this case, the images may further be classified and stored according to the similarity value between the objects included in the images so that the stored images can be output sequentially according to the similarity value between the objects in the images.

A similarity judgment apparatus of the present invention is an apparatus for judging a similarity value between images related to or attached with characteristic information representing a characteristic of each of objects therein, and the similarity judgment apparatus comprises:

object evaluation means for calculating a similarity value between the objects included in the images, based on the characteristic information; and

image evaluation means for calculating the similarity value between the images, based on the similarity value between the objects.

The similarity judgment apparatus of the present invention may further comprise storage means for storing the images in classification according to the similarity value between the images.

In this case, the similarity judgment apparatus may further comprise output means for sequentially outputting the stored images according to the similarity value between the images.

Furthermore, the storage means may store the images by further classifying the images according to the similarity value between the objects so that the output means can sequentially output the stored images, based on the similarity value between the objects.

The similarity judgment method of the present invention may be provided as a program to cause a computer to execute the method.

According to the present invention, the similarity value between the objects in the images is calculated first based on the characteristic information on the objects, and the similarity value between the images is calculated according to the similarity value between the objects. Therefore, the similarity value between the images can be calculated based on the objects that affect impression of the images. In this manner, similarity between the images can be judged in a manner that is closer to human perception.

By classifying and storing the images based on the similarity value between the images, when a predetermined one of the images is searched for or output, the images similar to the predetermined image can also be searched for and output with ease.

Furthermore, similarity between the images can be recognized with ease by outputting the images sequentially according to the similarity value.

Moreover, if the images are further classified, stored and sequentially output according to the similarity value between the objects, any of the images including a specific one of the objects can be output. Therefore, the images including the specific object can be collected easily.

### BRIEF DESCRIPTION OF THE DRAWINGS

FIG. 1 is a block diagram showing the configuration of an image classification apparatus comprising a similarity judgment apparatus as an embodiment of the present invention;

FIG. 2 shows characteristic information included in a metadata set;

FIG. 3 shows examples of object names;

FIG. 4 shows an example of a self-organizing map;

FIG. 5 shows specific examples of characteristic information;

FIG. 6 shows an example of a result of a search for similar object candidates;

FIG. 7 is a table showing a calculation result of evaluation values;

FIG. 8 shows the table in which the evaluation values are sorted in descending order;

FIG. 9 shows an example of an image database;

FIG. 10 is a flow chart showing procedures carried out in this embodiment; and

FIG. 11 shows another example of the image database.

### DESCRIPTION OF THE PREFERRED EMBODIMENT

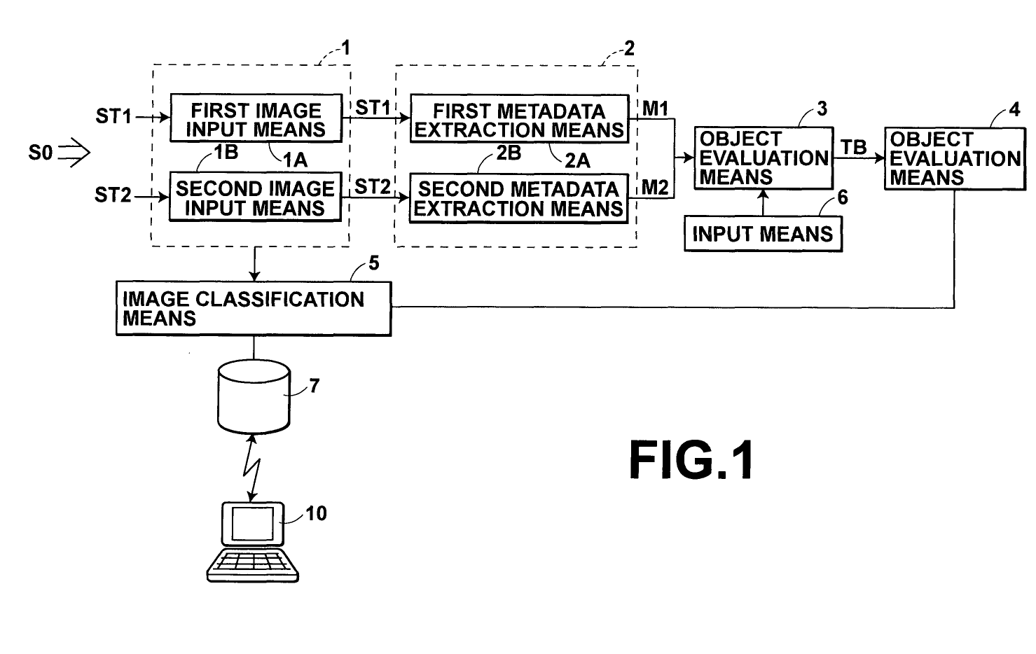

Hereinafter, an embodiment of the present invention will be explained with reference to the accompanying drawings. FIG. 1 is a block diagram showing the configuration of an image classification apparatus comprising a similarity judgment apparatus as the embodiment of the present invention. As shown in FIG. 1, the image classification apparatus classifies and stores image data sets Sk (k=1˜n) according to similarity between the image data sets Sk. The image classification apparatus comprises image input means 1, metadata extraction means 2, object evaluation means 3, image evaluation means 4, image classification means 5, input means 6, and storage means 7. The image input means 1 comprises first image input means 1A and second image input means 1B for receiving input of two of the image data sets (hereinafter referred to as image data sets ST1 and ST2) that are selected from the image data sets Sk as similarity evaluation targets. The metadata extraction means 2 comprises first metadata extraction means 2A and second metadata extraction means 2B for respectively extracting metadata sets M1 and M2 attached to the image data sets ST1 and ST2. The object evaluation means 3 calculates evaluation values representing similarity between objects included in images SG1 and SG2 represented by the image data sets ST1 and ST2, based on characteristic information included in the metadata sets M1 and M2, as will be explained later. The image evaluation means 4 calculates a similarity value R0 between the images SG1 and SG2, based on the evaluation values regarding the similarity between the objects found by the object evaluation means 3. The image classification means 5 classifies the image data sets ST1 and ST2, based on the similarity value R0 between the images SG1 and SG2. The input means 6 is used for inputting various kinds of information to the object evaluation means 3. The storage means 7 stores the image data sets Sk that have been classified. The storage means 7 is connected to a terminal 10 via a network.

In this embodiment, the metadata sets are attached to the image data sets Sk. The metadata sets include the characteristic information on the objects in the images SGk represented by the image data sets Sk. In the case where the number of the objects in each of the images SGk is not one, the characteristic information is included in the metadata sets for each of the objects therein.

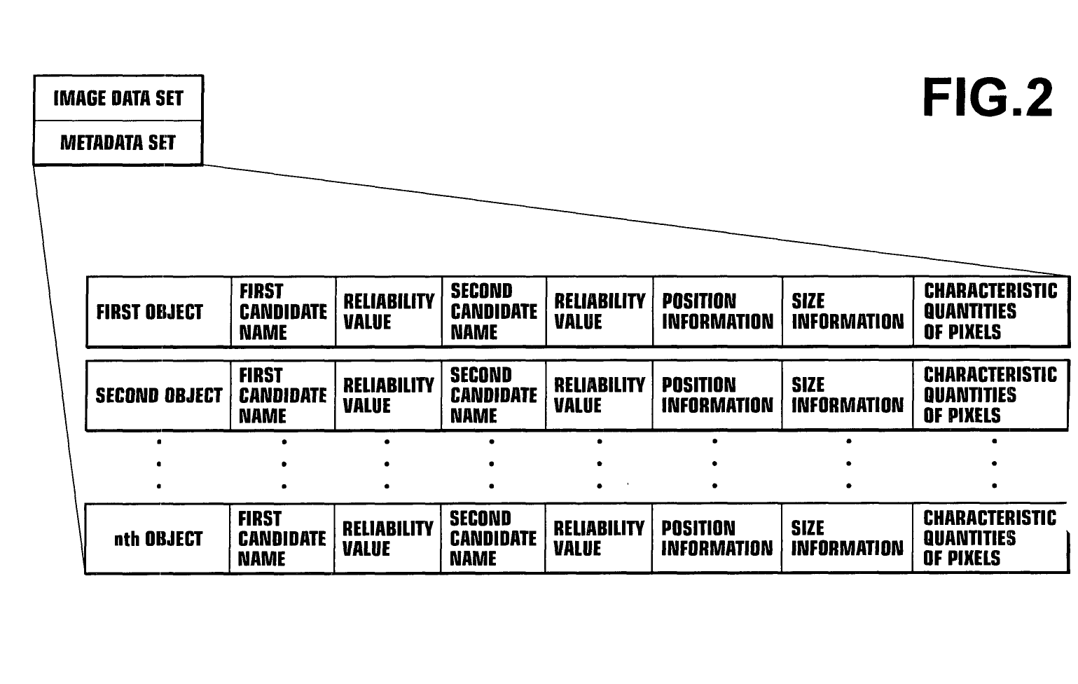

In this embodiment, the characteristic information included in the metadata sets comprises items such as the name of each of the objects, (a first candidate name and a second candidate name), a reliability value on the object name, position and size information of the corresponding object, and characteristic quantities extracted from pixels of the corresponding object, as shown in FIG. 2.

How the names of the objects are given to the objects in the images SGk will be explained first. Each of the images SGk is divided into object regions for each of the objects therein. The division into the object regions can be carried out according to various methods. For example, in one method, outlines are extracted from one of the images SGk, and a region surrounded by the outlines is defined as the object region. In another method, a region wherein brightness is constant is divided as the object region, based on brightness information of one of the images SGk. In still another method, a region of the same color is defined as the object region, according to color information of one of the images SGk.

Each of the object regions is further divided into small regions (such as a region of 64×64 pixels), and the characteristic quantities are calculated for all the small regions. The characteristic quantities refer to an average color therein and high frequency components in x and y directions, for example. Based on characteristic quantity vectors obtained from the characteristic quantities of the small regions, the name of the object to which each of the small regions belongs is judged. The judgment is made based on an output from a self-organizing map. The output is obtained by inputting the characteristic quantity vectors to the self-organizing map that has been trained regarding the names of the objects.

The self-organizing map is obtained by training a neural network comprising an input layer and an output layer having a plurality of units laid out two-dimensionally, and the characteristic quantity vectors corresponding to the object names are input thereto.

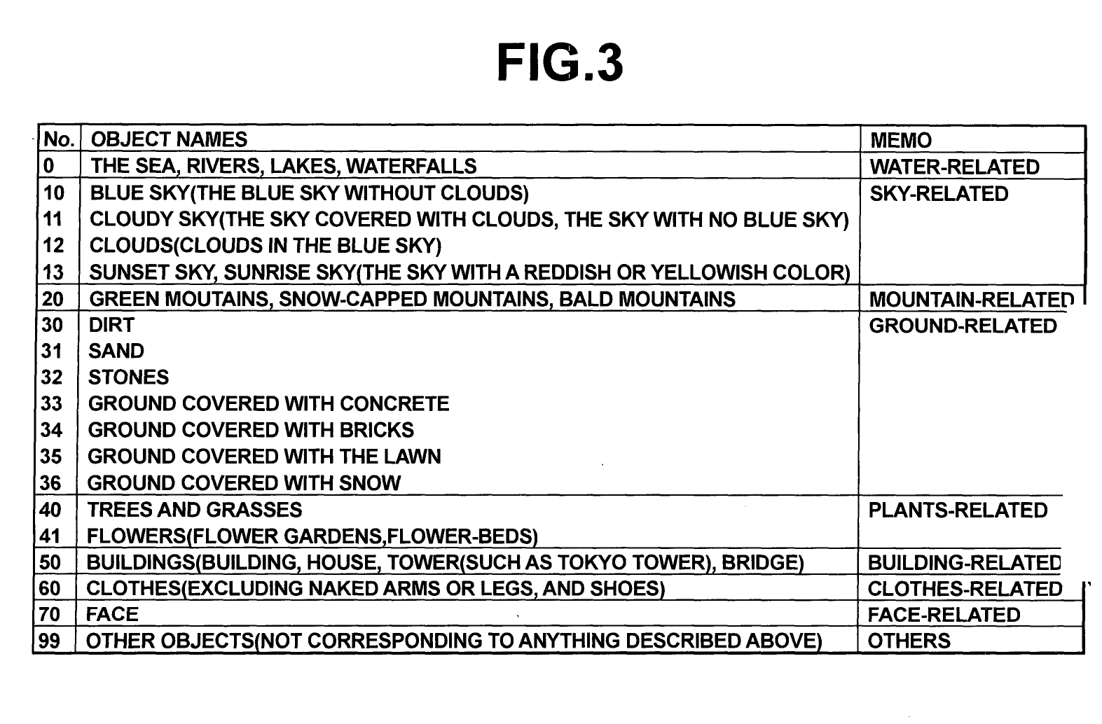

FIG. 3 shows examples of the names of the objects. As shown in FIG. 3, the respective object names have numbers representing categories thereof. The number 0 represents the object names related to water. The numbers whose digit of ten is 1, such as 11 and 13, represent the object names related to the sky. The numbers in the twenties represent the object names related to mountains, while the numbers in the thirties represent the object names related to the ground. The numbers in the forties, the fifties, the sixties, and the seventies respectively represent the object names related to plants, buildings, clothes, and faces. The number 99 represents the object names other than those described above.

When the self-organizing map is trained, reference characteristic quantity vectors used as references regarding the object names are input sequentially to all the units in the input layer of the neural network. The respective units in the input layer are connected to the respective units of the output layer by connection weights in accordance with the reference characteristic quantity vectors. The connection weights of one of the units having the closest fit to each of the input reference vectors (the unit is called the winner) are updated so as to become close to the corresponding input reference vector. In this manner, the training is carried out, and the connection weights of the units close to the winner are also updated to become close to the input reference vector. Consequently, the neighboring units have the connection weights that are similar to each other, and a range of the units having the similar connection weights becomes narrower as the training progresses.

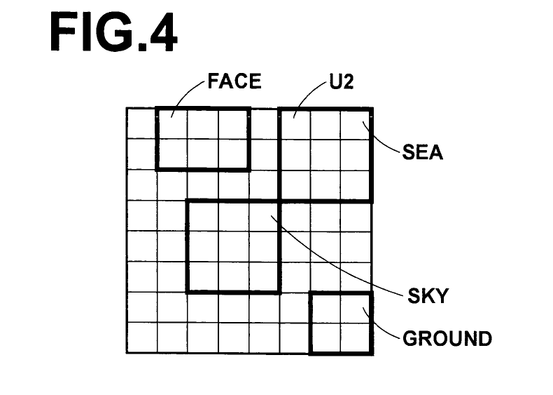

Therefore, the units classified roughly in an initial stage of the training are classified according to the reference characteristic quantity vectors corresponding to the object names after repetition of the training. For example, assume the case where the object names are “sea”, “sky”, “ground”, and “face”, for the sake of simple explanation. The units comprising the self-organizing map are classified according to the four object names, as shown in FIG. 4. In each of the units in the output layer, the name of the corresponding object and a reliability value thereof (shown as percentage) are set according to a result of the training. For example, in units U1 and U2 shown in FIG. 4, the names and the reliability values are set as “sea:0:90%” and “sea:0:50%”.

When one of the characteristic quantity vectors obtained from the characteristic quantities of one of the small regions is input to the self-organizing map that has been subjected to the training, one of the units in the output layer having the connection weights that are closest to the input characteristic quantity vector responds. Since each of the units in the output layer has the object name and the reliability value thereof according to the training result, the object name and the reliability value thereof are found, such as “sky:10%”, regarding the small region from which the input characteristic quantity vector has been obtained, according to a position of the unit in the output layer connected to the units in the input layer by the connection weights that are most similar to the input characteristic quantity vector.

The object names are found for all the small regions, and the object name observed most frequently in the small regions in each of the object regions and the reliability value thereof become the first candidate name and the reliability value of the corresponding object region, that is, of the corresponding object. The object name having the second-largest frequency and the reliability value thereof become the second candidate name and the reliability value thereof.

Each of the metadata sets may include not only the first and second candidate names and the reliability values thereof but also more candidate names and the reliability values thereof.

The position information of each of the objects refers to barycentric coordinates of the corresponding object region or barycentric coordinates of a rectangular region to which the corresponding object is circumscribed.

The size information of the object refers to a proportion of the number of pixels in each of the object regions to the number of all pixels in the entire image, or a proportion of an area of the object region to an area of the entire image.

The characteristic quantities of the pixels in each of the objects refer to averages or variances of brightness Y and color differences Cr and Cb of the pixels, and a proportion T of a texture component therein to the entire image. Alternatively, each of the object regions may be divided into the small regions, and the averages or the variances of brightness Y and color differences Cr and Cb of the small regions, and the proportion T of a texture component therein may be used as the characteristic quantities.

The characteristic information other than the object names is included in the metadata sets after normalization thereof. In this example, as for the position information, the barycentric coordinates (x,y) of each of the objects is normalized by lengths of the corresponding image in the x and y directions. More specifically, values (x/the length in the x direction×100, y/the length in the y direction×100) are calculated. As for the size information, the proportion of the object region to the entire image is used. More specifically, a value (the number of pixels in the object region/the number of all the pixels in the corresponding image×100) is used as the size information.

For the brightness Y, an average of the object brightness is normalized by a maximal brightness thereof. More specifically, in the case where the brightness is represented by 8-bit data having 255 as the maximum value, the brightness information is calculated as a value (the average of the brightness value Y ranging from 0 to 255/255×100). For the color differences Cr and Cb, averages of the color differences Cr and Cb are normalized by a maximal color difference. More specifically, in the case where the color differences are represented by 8-bit data, the color difference information is calculated as values (the averages of the color difference values ranging from −255 to 255/255×100).

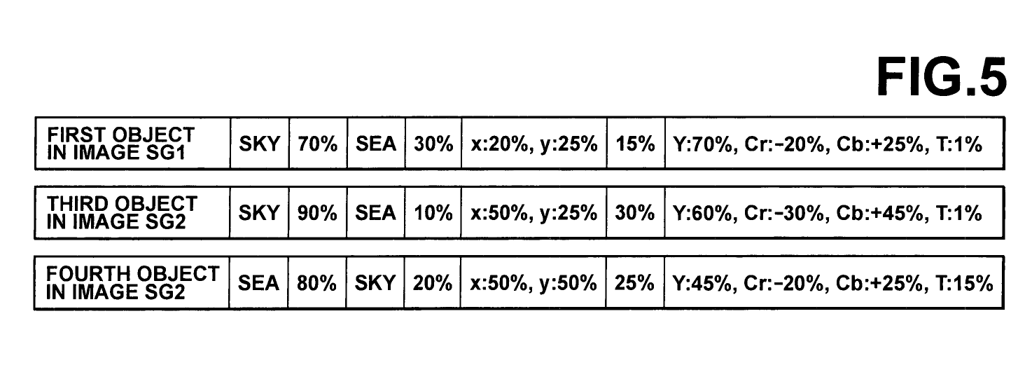

FIG. 5 shows an example of the characteristic information. As shown in FIG. 5, for a first object in the image SG1, the first candidate name is “sky” and the reliability value thereof is 70%. The second candidate name is “sea” and the reliability value thereof is 30%. The position information is “x:20%, y:25%”, and the size information is “15%”. The characteristic quantities of the pixels are “Y:70%, Cr:−20%, Cb:+25%, T:1%”.

For a third object in the image SG2, the first candidate name is “sky” and the reliability value thereof is “90%”. The second candidate name is “sea” and the reliability value thereof is “10%”. The position information is “x:50%, y:25%”, and the size information is “30%”. The characteristic quantities of pixels are “Y:60%, Cr:−30%, Cb:+45%, T:1%”.

For a fourth object in the image SG2, the first candidate name is “sea” and the reliability value thereof is “80%”. The second candidate name is “sky” and the reliability value thereof is “20%”. The position information is “x:50%, y:50%”, and the size information is “25%”. The characteristic quantities of pixels are “Y:45%, Cr:−20%, Cb:+25%, T:15%”.

In FIG. 5, the first and second candidate names are shown as the names themselves, such as “sea” or “sky”. However, the candidate names are actually represented by the numbers shown in FIG. 3.

The first and second image input means 1A and 1B in the image input means 1 are used for inputting the image data sets ST1 and ST2. The first and second image input means 1A and 1B comprise a media drive for reading the image data sets ST1 and ST2 from a recording medium, or a communication interface for receiving the image data sets ST1 and ST2 transferred via a network.

The first and second metadata extraction means 2A and 2B in the metadata extraction means 2 are used for extracting the metadata sets M1 and M2 attached to the image data sets ST1 and ST2.

The object evaluation means 3 evaluates the similarity for all combinations of the objects included in the images SG1 and SG2, based on the characteristic information thereof included in the metadata sets M1 and M2. The evaluation of the similarity is carried out by calculating the evaluation values representing the similarity in the form of percentages. Hereinafter, the evaluation will be explained.

Firstly, the objects in the image SG2 whose first or second candidate name is the same as the first candidate name of the first object in the image SG1 (hereinafter referred to as similar object candidates) are found. For example, if the first candidate name of the first object in the image SG1 is “sky”, all the objects whose first or second candidate name is “sky” in the image SG2 are found as the similar object candidates. Since the candidate names are represented by the numbers as shown in FIG. 3, all the similar object candidates can be found by comparing the number of the first candidate name of the first object in the image SG1 with the numbers of the first and second candidate names of all the objects in the image SG2.

For example, if the characteristic information is as shown in FIG. 5, the first candidate name of the first object in the image SG1 is “sky”, and the first candidate name of the third object and the second candidate name of the fourth object in the image SG2 are also “sky”. Therefore, the third and fourth objects in the image SG2 are the similar object candidates regarding the first object in the image SG1.

The evaluation values are set to 0% for non-similar object candidates whose first or second candidate name is not the same as the first candidate name of the first object in the image SG1.

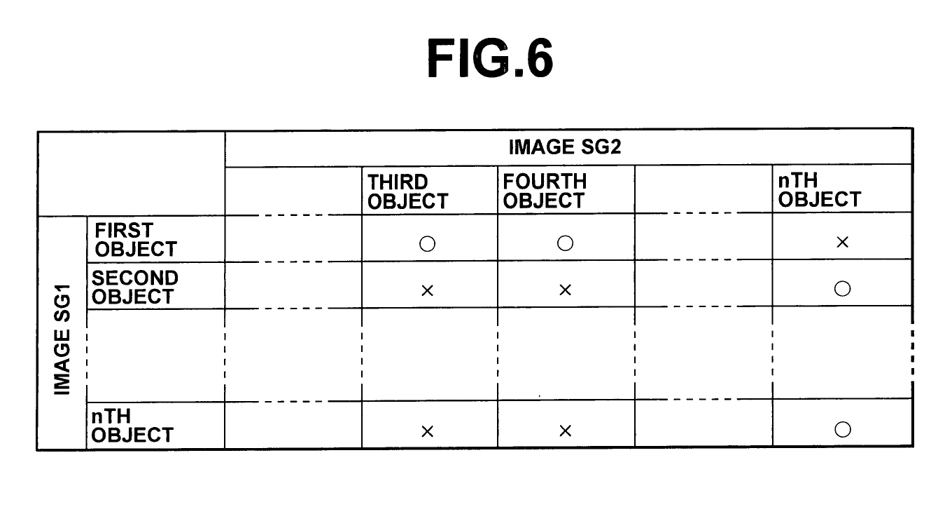

Likewise, the first candidate name of a kth object (k=1˜n) in the image SG1 is compared with the first and second candidate names of all the objects in the image SG2, and the similar object candidates are found for all the objects in the image SG1. FIG. 6 shows a result of the similar object candidates. In FIG. 6, circles ◯ and crosses X represent the similar object candidates and the non-similar object candidates for the kth object in the image SG1, respectively.

The evaluation values are then found for all the similar object candidates for the kth object in the image SG1. The evaluation values are calculated as follows:

evaluation value=(2−distance between the characteristic quantities×weight coefficient)/2×reliability value C1×reliability value C2 (1)

where the reliability value C1 and the reliability value C2 refer to the reliability value of the first candidate name of the kth object in the image SG1 and the reliability value of the first or second candidate name of the similar object candidate in the image SG2 corresponding to the first candidate name of the kth object in the image SG1, respectively.

The weight coefficient is used to determine which is more important between the distance and the reliability value, and is usually set to 1. The distance between the characteristic quantities is calculated by the following equation:

distance=((Y1-Y2)²+(Cr1-Cr2)²+(Cb1-Cb2)²+(T1-T2)²+Wa×(position difference)²+Wb(area difference)²)^{1/2} (2)

In the Equation (2), if the distance is more than 1, the distance is set to 1. The indices 1 and 2 of the brightness Y, the color differences Cr and Cb, and the texture T correspond to the images SG1 and SG2, respectively. Wa and Wb are weight coefficients. Regardless of the positions or the sizes of the objects, the weight coefficients Wa and Wb can be set to a small number by an input from the input means 6 so that the position difference and the area difference can contribute less to similarity judgment in the case where the objects such as sea in the two images are desired to be judged similar regardless of the positions of the sea or the areas occupied by the sea in the two images, for example.

The area difference is a difference between values of the size information in the characteristic information. The position difference can be calculated according to the equation below:

position difference=((x1-x2)²+(y1-y2)²)^{1/2} (3)

In the case where the similar object candidates have the same candidate name as the second candidate name of the kth object in the image SG1, the evaluation values are calculated according to Equation (1) for the second candidate name of the kth object. In this case, the larger value between the evaluation values for the first and second candidate names is used as the final evaluation value for the kth object in the image SG1.

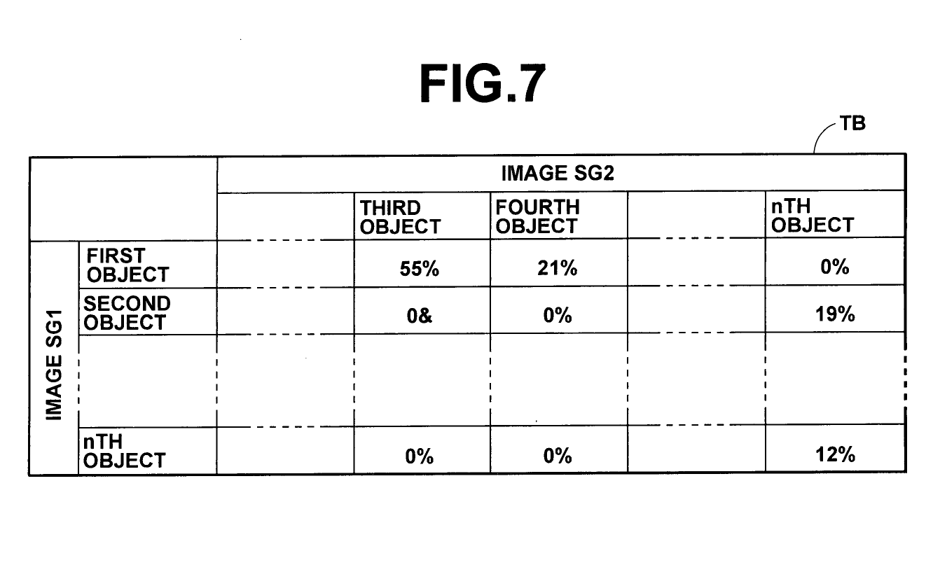

In the case where the weight coefficients Wa and Wb are 0 and the sky and the sea are found only in the first object of the image SG1 and in the third and fourth objects in the image SG2, the evaluation values between the first object in the image SG1 and the third object in the image SG2 are 55% and 26% regarding the sky and the sea, respectively. Therefore, the larger value 55% is used as the final evaluation value between the two objects. Likewise, the evaluation values regarding the first object in the image SG1 and the fourth object in the image SG2 are 12% and 21% for the sky and the sea, respectively. Therefore, the evaluation value 21% is used as the final evaluation value between the two objects. FIG. 7 shows a table TB representing a result of the calculation of the evaluation values. The object evaluation means 3 outputs the table TB shown in FIG. 7 to the image evaluation means 4.

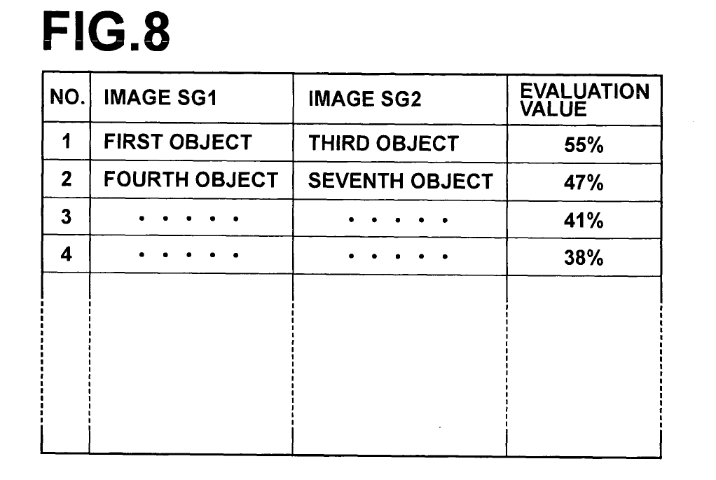

The image evaluation means 4 judges the similarity between the images SG1 and SG2, based on the table TB representing the evaluation result output from the object evaluation means 3. Hereinafter, how the similarity is judged will be explained. The image evaluation means 4 sorts the contents of the table TB shown in FIG. 7 into the table shown in FIG. 8, in descending order of the evaluation values between the objects. The evaluation values between the objects are used as they are, as the evaluation values in FIG. 8.

The similarity value between the images SG1 and SG2 is found according to Equation (4) below, based on a total of the evaluation values between the objects exceeding a reference value (40%, in this case):

similarity value R0=1−(reference value)/(the total) (4)

The higher the evaluation values are (that is, the higher a possibility of existence of the similar objects), the closer to 1 the similarity value R0 becomes. Furthermore, the larger the number of the objects having the higher evaluation values is, the closer to 1 the similarity value R0 becomes, since the term (reference value)/(the total) becomes smaller. This is because the similarity becomes higher in the case where the number of the objects such as sea, sky, and tree that agree between the images SG1 and SG2 becomes larger, than in the case where only the object “sky” agrees between the two images SG1 and SG2.

In this embodiment, the similarity value R0 between the images SG1 and SG2 is 0.72. In the case where the evaluation values between the objects do not exceed the reference value, the similarity value R0 becomes 0. The image evaluation means 4 outputs the similarity value R0 between the two images to the image classification means 5.

The image classification means 5 compares the similarity value R0 input from the image evaluation means 4 with a predetermined image similarity range. In the case where the similarity value R0 is within the image similarity range, the images SG1 and SG2 are classified as similar images. The image classification means 5 then classifies the image data sets ST1 and ST2 according to the classification, and stores the image data sets ST1 and ST2 in the storage means 7 together with the classification result.

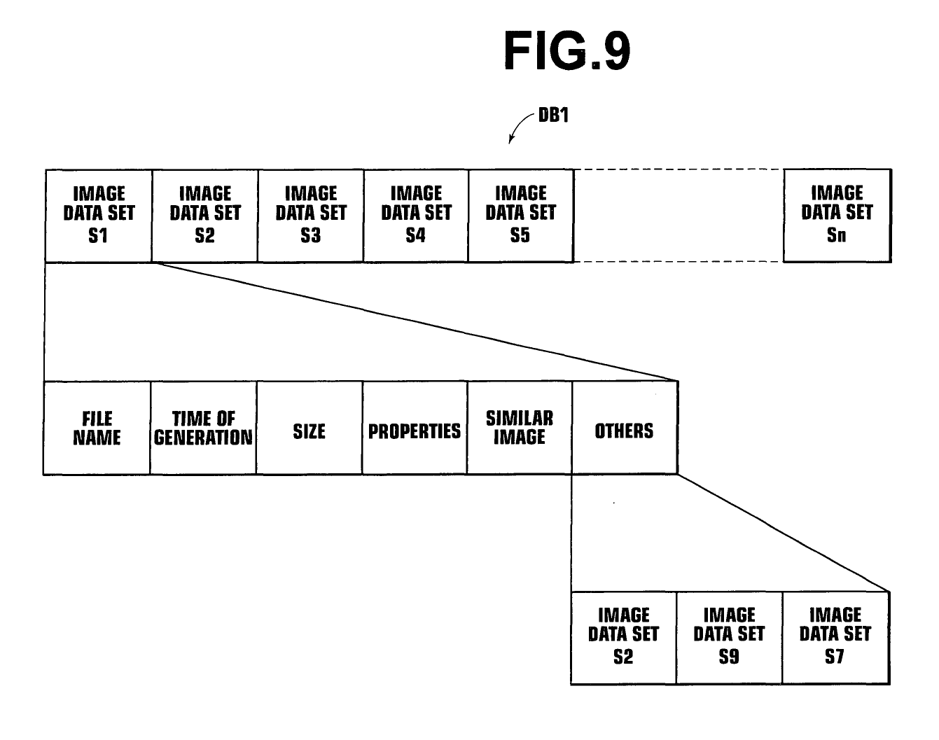

The procedures described above are repeated for all combinations of the image data sets Sk, and the similar images are classified in the same category and stored in the storage means 7. The storage means 7 has an image database DB1 regarding the image data sets Sk. FIG. 9 shows an example of the image database. As shown in FIG. 9, the image database DB1 has information on the file name, the time of generation, a size, properties, and the similar images, regarding each of the image data sets Sk stored in the storage means 7. The similar images are stored in order of higher similarity value R0 between the image represented by each of the image data set Sk and the images similar thereto. For example, as shown in FIG. 8, the similar images for the image data set ST1 are the images represented by the image data sets ST4, ST7 and ST3, in the order of higher similarity.

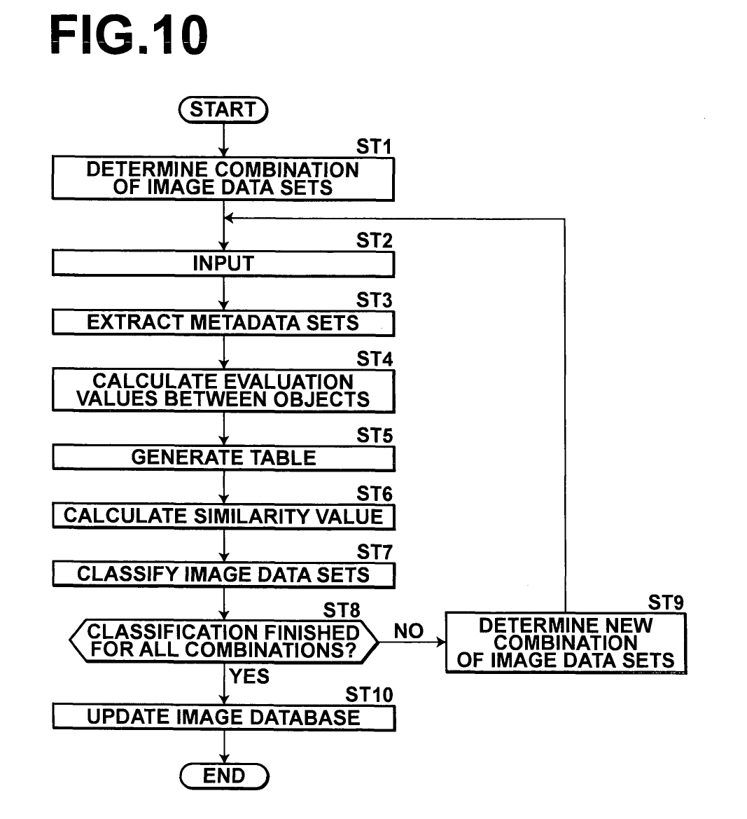

The operation of the embodiment will be explained next. FIG. 10 is a flow chart showing procedures carried out in this embodiment. The procedures of classifying the image data sets according to the similarity value will be explained below. The combination of the image data sets ST1 and ST2 to be subjected to similarity judgment is determined, among the image data sets Sk (Step S1). The two image data sets are then input to the first and second image input means 1A and 1B (Step S2). The first and second metadata extraction means 2A and 2B extract the metadata sets M1 and M2 from the image data sets ST1 and ST2 (Step S3), and inputs the metadata sets M1 and M2 to the object evaluation means 3.

The object evaluation means 3 calculates the evaluation values between the objects, based on the characteristic information of the objects in the metadata sets M1 and M2 (Step S4), and generates the table TB shown in FIG. 7 (Step S5). The table TB is input to the image evaluation means 4, and the image evaluation means 4 calculates the similarity value R0 between the images (Step S6). The similarity value R0 is input to the image classification means 5, and the image classification means 5 classifies the image data sets ST1 and ST2, based on the similarity value R0 (Step S7).

Whether the classification has been carried out for all the combinations of the image data sets Sk is then judged (Step S8). If a result at Step S8 is negative, the combination is newly determined (Step S9), and the process returns to Step S2. If the result at Step S8 is affirmative, the image database DB1 is updated according to the classification result (Step S10) to end the process.

In the case where an output instruction is input from the terminal 10 connected to the storage means 7 via the network regarding one of the image data sets Sk stored in the storage means 7, the image database DB1 is referred to, and the similar image data sets are output to the terminal 10 in order of higher similarity, together with the image data set of the output instruction. For example, if the image database DB1 is as shown in FIG. 8 and the terminal 10 inputs the output instruction regarding the image data set ST1, the image data sets S4, S7, and S3 are output in this order together with the image data set ST1 to the terminal 10.

In the case where the terminal 10 searches for a portion of the image data sets Sk stored in the storage means 7 according to a predetermined search condition, the image database DB1 is referred to, and the image data sets similar to the searched one of the image data sets are output in order of higher similarity, together with the searched image data set. For example, in the case where the image database DB 1 is as shown in FIG. 8, if the searched one of the image data sets is ST1, the image data sets S4, S7, and S3 are output in this order to the terminal 10, together with the image data set ST1.

As has been described above, in this embodiment, the evaluation values are calculated first between the objects in the images SG1 and SG2, based on the characteristic information on the objects, and the similarity value R0 is found for the images SG1 and SG2, based on the evaluation values between the objects. Therefore, the similarity between the images can be calculated based on the objects that affect impression of the images, and the similarity can be judged in a manner closer to human sensation.

By storing the image data sets Sk in classification, the image data sets similar to a predetermined one of the image data sets can also be output or searched for with ease in the case where the predetermined image data set is output or searched for from the image data sets stored in the storage means.

By classifying the image data sets Sk according to the similarity value between the images and by sequentially outputting the image data sets similar to the predetermined image data set in the case of output instruction of the predetermined image data set, the similarity between the images can be easily recognized.

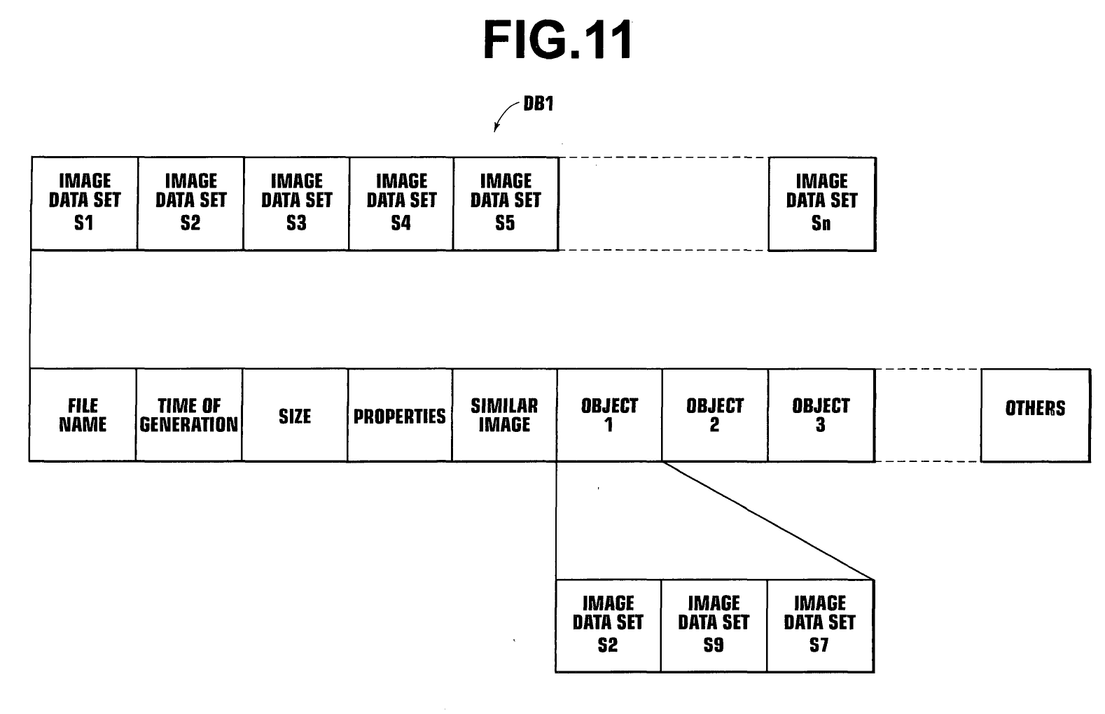

In the above embodiment, the image database DB1 may store information on the objects in each of the images and on the image data sets whose evaluation values with the objects are high, as shown in FIG. 11. In this case, the terminal 10 connected to the storage means 7 enables selection of the objects in the output image data set. In the case where the image database DB1 is as shown in FIG. 11, if the output instruction is input regarding the image data set ST1 and the object 1 is selected from the objects include in the image represented by the image data set ST1, the image data sets ST2, S9, and S7 having the high evaluation values with the object 1 are output in this order to the terminal 10. In this manner, the terminal 10 can easily collect the images having a predetermined one of the objects such as sea.

In the above embodiment, an image data set may be input from the terminal 10 so that the image data sets similar to the input image data set can be searched for from the image data sets Sk stored in the storage means 7 and output to the terminal 10. In this case, the similarity value R0 is calculated in the same manner described above, based on a metadata set of the input image data set and the metadata sets of the image data sets Sk stored in the storage means 7. The image data sets similar to the input image data set are output from the storage means 7 to the terminal 10 in order of higher similarity value R0.

As has been described above, the similarity judgment method of the present invention can be applied to a search for image data sets similar to an input image data set.

What is claimed is:

1. A similarity judgment method for judging a similarity value between images related to or attached with characteristic information representing a characteristic of each of objects therein, the similarity judgment method comprising the steps of:
calculating a similarity value between the objects included in the images, based on the characteristic information;
calculating the similarity value between the images, based on the similarity value between the objects.

2. The similarity judgment method according to claim 1, wherein the characteristic information is included in metadata of image data representing the images.

3. The similarity judgment method according to claim 1, wherein the characteristic information refers to at least one of items comprising a candidate of the name of each of the objects, a reliability value representing likelihood of each of the objects having the name, position information representing a position of each of the objects in a corresponding one of the images, size information representing a size of each of the objects, and a statistic value regarding characteristic quantities of each of the objects.

4. The similarity judgment method according to claim 3, wherein, in the case where the characteristic information includes the candidate of the name of each of the objects, the candidate of the name is determined based on an output from a self-organizing map, the output being obtained by inputting a characteristic quantity vector obtained from the characteristic quantities of each of the objects to the self-organizing map that has been trained regarding the names of the objects.

5. The similarity judgment method according to claim 1, further comprising the step of storing the images by classifying the images according to the similarity value between the images.

6. The similarity judgment method according to claim 5, further comprising the step of sequentially outputting the stored images according to the similarity value between the images.

7. The similarity judgment method according to claim 6, further comprising the steps of:
storing the images by further classifying the images according to the similarity value between the objects included in the images; and
sequentially outputting the stored images according to the similarity value between the objects in the images.

8. A similarity judgment apparatus for judging a similarity value between images related to or attached with characteristic information representing a characteristic of each of objects therein, the similarity judgment apparatus comprising:
object evaluation means for calculating a similarity value between the objects included in the images, based on the characteristic information; and
image evaluation means for calculating the similarity value between the images, based on the similarity value between the objects.

9. The similarity judgment apparatus according to claim 8, wherein the characteristic information is included in metadata of image data representing the images.

10. The similarity judgment apparatus according to claim 8, wherein the characteristic information refers to at least one of items comprising a candidate of the name of each of the objects, a reliability value representing likelihood of each of the objects having the name, position information representing a position of each of the objects in a corresponding one of the images, size information representing a size of each of the objects, and a statistic value regarding characteristic quantities of each of the objects.

11. The similarity judgment apparatus according to claim 10, wherein, in the case where the characteristic information includes the candidate of the name of each of the objects, the candidate of the name is determined based on an output from a self-organizing map, the output being obtained by inputting a characteristic quantity vector obtained from the characteristic quantities of each of the objects to the self-organizing map that has been trained regarding the names of the objects.

12. The similarity judgment apparatus according to claim 8, further comprising storage means for storing the images by classifying the images according to the similarity value between the images.

13. The similarity judgment apparatus according to claim 12, further comprising output means for sequentially outputting the stored images according to the similarity value between the images.

14. The similarity judgment apparatus according to claim 13, wherein the storage means stores the images by further classifying the images according to the similarity value between the objects in the images, and the output means sequentially outputs the stored images, based on the similarity value between the objects.

15. A program for causing a computer to execute a similarity judgment method for judging a similarity value between images related to or attached with characteristic information representing a characteristic of each of objects therein, the program comprising the steps of:
calculating a similarity value between the objects included in the images, based on the characteristic information;
calculating the similarity value between the images, based on the similarity value between the objects.

16. The program according to claim 15, wherein the characteristic information is included in metadata of image data representing the images.

17. The program according to claim 15, wherein the characteristic information refers to at least one of items comprising a candidate of the name of each of the objects, a reliability value representing likelihood of each of the objects having the name, position information representing a position of each of the objects in a corresponding one of the images, size information representing a size of each of the objects, and a statistic value regarding characteristic quantities of each of the objects.

18. The program according to claim 17, wherein, in the case where the characteristic information includes the candidate of the name of each of the objects, the candidate of the name is determined based on an output from a self-organizing map, the output being obtained by inputting a characteristic quantity vector obtained from the characteristic quantities of each of the objects to the self-organizing map that has been trained regarding the names of the objects.

19. The program according to claim 15, further comprising the step of storing the images by classifying the images according to the similarity value between the images.

20. The program according to claim 19, further comprising the step of sequentially outputting the stored images according to the similarity value between the images.

21. The program according to claim 20, further comprising the steps of:
storing the images by further classifying the images according to the similarity value between the objects included in the images; and
sequentially outputting the stored images according to the similarity value between the objects in the images.
